(19) United States
(12) Patent Application Publication
(10) Pub. No.: US 2026/0316742 A1
(43) Pub. Date: Oct. 15, 2026

(54) METHOD FOR CONTROLLING DRIVING OF A HYBRID VEHICLE

(71) Applicants: HYUNDAI MOTOR COMPANY, Seoul (KR); KIA CORPORATION, Seoul (KR)

(72) Inventor: Jee Wook Huh, Hwaseong-si (KR)

(73) Assignees: HYUNDAI MOTOR COMPANY, Seoul (KR); KIA CORPORATION, Seoul (KR)

(21) Appl. No.: 19/354,254

(22) Filed: Oct. 9, 2025

(30) Foreign Application Priority Data
Apr. 10, 2025 (KR) 10-2025-0046992

(51) Int. Cl. B60W 20/15; B60K 6/24; B60K 6/26; B60K 6/387; B60W 10/02; B60W 10/06; B60W 10/08; B60W 20/40; B60W 30/18; B60W 30/184; B60W 40/12

(52) U.S. Cl. CPC B60W 20/15; B60K 6/24; B60K 6/26; B60K 6/387; B60W 10/02; B60W 10/06; B60W 10/08; B60W 20/40; B60W 30/18027; B60W 30/184; B60W 40/12; B60W 2510/0208; B60W 2510/0241; B60W 2510/0275; B60W 2510/0291; B60W 2510/0638; B60W 2510/0657; B60W 2510/0695; B60W 2510/081; B60W 2510/107; B60W 2520/10; B60W 2540/10; B60W 2540/12; B60W 2710/021; B60W 2710/0666; B60W 2710/083; B60Y 2200/92

(57) ABSTRACT

A method for controlling the driving of a hybrid vehicle includes increasing engine torque, prior to vehicle launch, within a range permitted by at least one of motors or friction elements of a hybrid powertrain based on a demand for increased power performance, and starting the vehicle by engaging an engine clutch in response to an initiation of vehicle launch.

### CROSS-REFERENCE TO RELATED APPLICATION

The present application claims priority to Korean Patent Application No. 10-2025-0046992, filed on Apr. 10, 2025, the entire contents of which are incorporated herein by reference.

### FIELD

Various aspects of the present disclosure relate to a method for controlling the driving of a hybrid vehicle, and more particularly, to a control method for enhancing the power performance of the vehicle.

### BACKGROUND

The power performance of a vehicle may be evaluated based on the time taken for the vehicle to launch and reach a certain speed or distance., A vehicle with superior power performance requires less time to reach a reference speed or distance.

Hybrid vehicles have primarily aimed to improve fuel or electric efficiency as their main technical objective, so there has been relatively low demand for power performance. However, in recent years, the demand for enhanced power performance has gradually increased, particularly among high-performance or premium vehicles.

The above description of the related art is intended to provide a better understanding of the background of the present disclosure and should not be taken as an admission of prior art known to those of ordinary skill in the art.

### SUMMARY

Various aspects of the present disclosure are directed to providing a method for controlling the driving of a hybrid vehicle, which minimizes cost increases while enhancing power performance, thereby meeting consumer demands and increasing product value.

The technical problems to be addressed by the present disclosure are not limited to the technical problems described above, and other undescribed technical problems should be clearly understood by those having ordinary skill in the art to which the present disclosure pertains from the description below.

According to an embodiment of the present disclosure, a method for controlling the driving of a hybrid vehicle includes: increasing an engine torque, prior to vehicle launch, within a range permitted by at least one motor or friction elements of a hybrid powertrain, based on a demand for increased power performance; and starting the vehicle by engaging an engine clutch in response to an initiation of the vehicle launch.

The hybrid powertrain may be configured to include: an engine; the at least one motor including a first motor directly connected to the engine, and a second motor directly connected to a transmission; and the engine clutch configured to control a connection between the first motor and the second motor.

The motors of the hybrid powertrain may be the first motor and the second motor, and the friction elements of the hybrid powertrain may include the engine clutch and low-gear friction elements of the transmission.

In an embodiment, increasing the engine torque may include, based on determining that the engine clutch is open, and a reference speed of the first motor is greater than or equal to the minimum operable engine speed, determining the engine torque by adding an engine inertia torque to the maximum torque of the first motor.

In the increasing of the engine torque, the first motor may be controlled based on the maximum torque of the first motor in a direction opposite to the engine torque.

Increasing the engine torque may include, based on determining that the engine clutch is open, and a reference speed of the first motor is less than the minimum operable engine speed, determining the engine torque by adding engine inertia torque to the maximum torque of the first motor at the minimum operable engine speed.

In the increasing of the engine torque, the first motor may be controlled based on the maximum torque of the first motor at the minimum operable engine speed in a direction opposite to the engine torque.

In another embodiment, increasing the engine torque may include, based on determining that the engine clutch is slipped, the second motor is stopped, and a reference speed of the first motor is greater than or equal to the minimum operable engine speed, determining the engine torque by adding an engine inertia torque and an engine clutch slip torque to the maximum torque of the first motor.

In the increasing of the engine torque, a control torque of the first motor may be set to the maximum torque of the first motor, the first motor may be controlled to apply this control torque in a direction opposite to the engine torque, and the engine clutch may be controlled based on the engine clutch slip torque, which is determined within a range that prevents damage to the engine clutch in a stationary state of the second motor.

Increasing the engine torque may include, based on determining that the engine clutch is slipped, the second motor is stopped, and a reference speed of the first motor is less than the minimum operable engine speed, determining the engine torque by adding an engine inertia torque and an engine clutch slip torque to the maximum torque of the first motor at the minimum operable engine speed.

In the increasing of the engine torque, the control torque of the first motor may be set to the maximum torque of the first motor at the minimum operable engine speed, the first motor may be controlled to apply this control torque in a direction opposite to the engine torque, and the engine clutch may be controlled based on the engine clutch slip torque, which is determined within a range that prevents damage to the engine clutch in a stationary state of the second motor.

Increasing the engine torque may include: based on determining that the engine clutch and the low-gear friction elements of the transmission are slipped, the second motor is rotated, and a reference speed of the first motor is greater than or equal to the minimum operable engine speed, determining the engine torque by adding an engine inertia torque and an engine clutch slip torque to the maximum torque of the first motor, and determining a rotational speed of the second motor based on an engine speed, a thermal capacity of the engine clutch, and a thermal capacity of the low-gear friction elements of the transmission.

In the increasing of the engine torque, the control torque of the first motor may be set to the maximum torque of the first motor, the first motor may be controlled to apply this control torque in a direction opposite to the engine torque, a torque of the second motor may be controlled within a range that prevents damage to the engine clutch under a condition that a difference exists between the engine speed and the rotational speed of the second motor, and the engine clutch may be controlled based on the engine clutch slip torque, which is determined within a range that prevents damage to the engine clutch under a condition that a difference exists between the engine speed and the rotational speed of the second motor.

Increasing the engine torque may include: based on determining that the engine clutch and the low-gear friction elements of the transmission are slipped, the second motor is rotated, and a reference speed of the first motor is less than the minimum operable engine speed, determining the engine torque by adding an engine inertia torque and an engine clutch slip torque to the maximum torque of the first motor at the minimum operable engine speed, and determining the rotational speed of the second motor based on the engine speed, a thermal capacity of the engine clutch, and a thermal capacity of the low-gear friction elements of the transmission.

In the increasing of the engine torque, the control torque of the first motor may be set to the maximum torque of the first motor at the minimum operable engine speed, the first motor may be controlled to apply this control torque in a direction opposite to the engine torque, the torque of the second motor may be controlled within a range that prevents damage to the engine clutch under a condition that a difference exists between the engine speed and the rotational speed of the second motor, and the engine clutch may be controlled based on the engine clutch slip torque, which is determined within a range that prevents damage to the engine clutch under a condition that a difference exists between the engine speed and the rotational speed of the second motor.

The rotational speed of the second motor may be determined by an equation, K*engine speed*low-gear friction element thermal capacity/(engine clutch thermal capacity+low-gear friction element thermal capacity), where K is a proportional constant.

The method further includes: engaging the low-gear friction elements based on determining that an engagement of the engine clutch has been completed during starting of the hybrid vehicle and that the rotational speed of the second motor is synchronized with a vehicle speed of the hybrid vehicle.

The demand for increased power performance may be determined based on simultaneous operation of an accelerator pedal and a brake pedal of the hybrid vehicle.

Based on the demand for increased power performance, if a predetermined reference time elapses following an initiation of the increasing of the engine torque, the increasing of the engine torque and the starting of the vehicle may be released.

In an embodiment, based on determining that a temperature of at least one of the friction elements in the powertrain rises higher than or equal to a predetermined reference temperature following an initiation of the increasing of the engine torque, the increasing of the engine torque and the starting of the vehicle may be terminated.

The method for controlling the driving of a hybrid vehicle according to the present disclosure enables improvement in power performance without additional cost increase in a hybrid vehicle, thereby meeting consumer demands and enhancing product value.

The effects of the present disclosure are not limited to those described above. Other undescribed effects will be clearly understood by those skilled in the art from the description below.

### BRIEF DESCRIPTION OF THE DRAWINGS

FIG. 1 is a diagram illustrating a vehicle configuration capable of performing a method for controlling the driving of a hybrid vehicle according to an embodiment of the present disclosure.

FIG. 2 is a graph illustrating a starting situation of the hybrid vehicle in FIG. 1.

FIG. 3 is a flowchart illustrating a method for controlling the driving of a hybrid vehicle according to an embodiment of the present disclosure.

FIG. 4 is a graph illustrating the method for controlling the driving of a hybrid vehicle in FIG. 3.

FIG. 5 is a flowchart illustrating a method for controlling the driving of a hybrid vehicle according to another embodiment of the present disclosure.

FIG. 6 is a graph illustrating the method for controlling the driving of a hybrid vehicle in FIG. 5.

FIG. 7 is a flowchart illustrating a method for controlling the driving of a hybrid vehicle according to another embodiment of the present disclosure.

FIG. 8 is a graph illustrating the method for controlling the driving of a hybrid vehicle in FIG. 7.

### DETAILED DESCRIPTION OF THE DISCLOSURE

In describing embodiments disclosed in the present specification, when a detailed description of a known related art is determined to obscure the gist of the present specification, the detailed description thereof has been omitted herein. In addition, the accompanying drawings are merely for easy understanding of the embodiments disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like used herein may be used to describe various components, but the components are not limited by these terms. The terms are used only for the purpose of distinguishing one component from another component.

Unless the context clearly dictates otherwise, the singular form includes the plural form.

In the present specification, the terms “comprising,” “includes” and/or “including,” “has” and/or “having,” and variations thereof are used to specify that a feature, a number, a step, an operation, a component, an element, or a combination thereof described herein exists. Such terms do not preclude the possibility of the presence or addition of one or more other features, numbers, steps, operations, components, elements, or combinations thereof.

As used in the description below, suffixes “module” and “part” for a component are used or interchangeably used solely for ease of preparation of the specification, and do not have different meanings and each of them does not function by itself.

When a component is referred to as being “connected” or “coupled” to another component, the component may be directly connected or coupled to another component, but it should be understood that sill another component may be present between the component and another component. Conversely, when a component is referred to as being “directly connected” or “directly coupled” to another component, it should be understood that still another component may not be present between the component and another component.

In addition, a unit or control unit included in names is only a term widely used in the naming of a controller that controls the specific function of a vehicle, but does not mean a generic function unit. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

A controller may include a communication device for communicating with other control units or sensors to control a responsible function, and a non-transitory memory for storing an operating program, instructions, a logic command, and input/output information. The controller may include one or more processors configured to perform determination, calculation, and decision which are necessary for controlling the corresponding function.

Any number of components or various components from any of the configurations described in the present specification may be included within the disclosure set forth in the present specification. Components may include any combination of the features described in the present specification and be arranged in any configuration among the various configurations described in the present specification. The concepts relating to the structure and arrangement of the components of the present disclosure, as well as their use and operation, may be applied not only to the specific embodiments discussed in the present specification but also to any number of embodiments in any combination. Embodiments, including those having various features in various arrangements, are described below with reference to the drawings.

Hereinafter, embodiments disclosed in the present specification are described in detail with reference to the drawings. The same reference numerals are given to the same or similar components regardless of reference numerals, and a repetitive description thereof will be omitted.

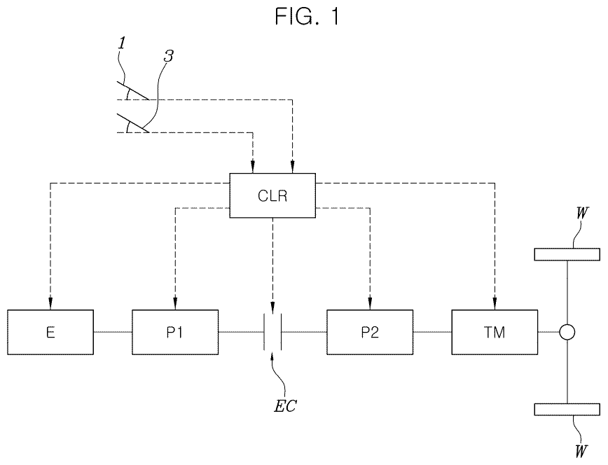

FIG. 1 is a diagram illustrating a vehicle configuration capable of performing a method for controlling the driving of a hybrid vehicle according to an embodiment of the present disclosure. A first motor (P1) is directly connected to a crankshaft of an engine (E), and a second motor (P2) is disposed on an input shaft of a transmission (TM). Between the first motor (P1) and the second motor (P2), an engine clutch (EC) is disposed, and the transmission (TM) is configured to provide power to driving wheels (W).

A controller (CLR) may be configured to control the engine (E), the first motor (P1), the second motor (P2), the transmission (TM), and the engine clutch (EC), and may function as the control unit that executes the method for controlling the driving of a hybrid vehicle as described in the present disclosure.

The controller (CLR) may also be physically configured as a single processor or electronic circuit as illustrated, or may be implemented by a combination of multiple processors or the like.

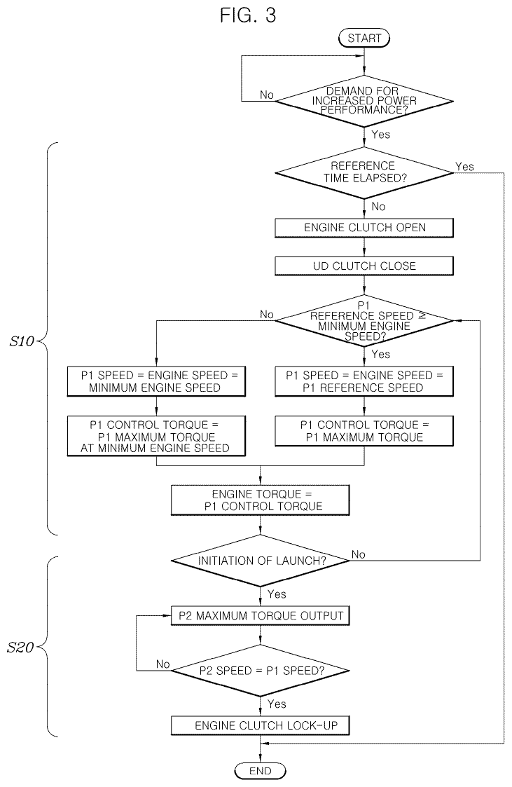

According to embodiment of the present disclosure, referring to FIGS. 3 to 8, the method for controlling the driving of a hybrid vehicle include: based on the demand for increased power performance, increasing engine torque (in step S10) within a range permitted by at least one of motors or friction elements of a hybrid powertrain prior to the vehicle launch, and starting the vehicle (in step S20) by engaging the engine clutch (EC) in response to the initiation of the vehicle launch.

The hybrid powertrain may be configured to include the engine, the first motor (P1) directly connected to the engine, the second motor (P2) directly connected to the transmission (TM), and the engine clutch (EC) configured to control the connection between the first motor (P1) and the second motor (P2).

The motors of the hybrid powertrain may be the first motor (P1) and the second motor (P2). The friction elements of the hybrid powertrain may be the engine clutch (EC) and low-gear friction elements of the transmission (TM).

The low-gear friction elements of the transmission (TM) here refer to friction elements used to implement the low gear stages, which are primarily employed when the vehicle starts from a stationary state, among a series of gear stages that the transmission (TM) may implement. For example, depending on the manufacturer, the term “the low-gear friction elements” may be interpreted as a general term for friction elements referred to as an underdrive clutch (UD clutch), underdrive brake, forward clutch, low clutch, or similar element.

In other words, the low-gear friction elements of the transmission (TM) may refer to as friction elements capable of performing slip control to vary frictional force in order to implement the gear stage used when the vehicle starts from a stationary state.

The controller (CLR) may determine that there is a demand for increased power performance based on simultaneous operation of an accelerator pedal 1 and a brake pedal 3.

For example, when a driver simultaneously operates the accelerator pedal 1 and the brake pedal 3 before the vehicle starts, the controller (CLR) may determine that there is a demand for increased power performance.

The demand for increased power performance may also be detected through the operation of a separate control switch connected to the controller (CLR).

Based on the determination of the demand for increased power performance, the controller (CLR) may notify the driver that the control process according to the present disclosure has been initiated, using audiovisual devices within the vehicle interior, such as an instrument panel or speaker. Furthermore, as described below, when the control process according to the present disclosure is terminated, the controller (CLR) may notify the driver of the termination, including the reason and other relevant details.

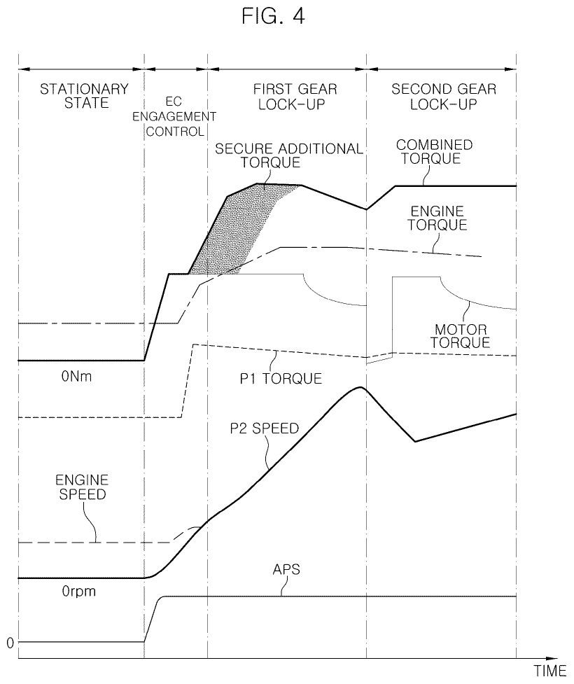

Referring to embodiments in FIGS. 3 and 4, in the step of increasing the engine torque (Step S10), if the engine clutch (EC) is open (i.e., a disengaged state), the low-gear friction elements of the transmission (TM) are engaged, and the reference speed of the first motor (P1) is higher than or equal to the minimum operable engine speed, the engine torque is determined by adding engine inertia torque to the maximum torque of the first motor (P1).

The reference speed of the first motor (P1) refers to the rotational speed at which, in the torque curve according to the rotational speed of the first motor (P1), a constant maximum torque is maintained as the rotational speed increases, and at which the torque begins to decrease immediately before the motor enters the constant power region. In other words, the reference speed of the first motor (P1) refers to the rotational speed at which the motor, while increasing in speed, transitions from a region of constant maximum torque to a region where torque begins to decrease. This reference speed corresponds to the point just before the motor enters the constant power region on its torque-speed curve.

In addition, the minimum operable engine speed refers to the lowest speed at which the engine may overcome the internal friction of the engine and continue to operate, and may be understood as the speed required for idle operation of the engine, for example.

In addition, the engine inertia torque refers to the torque required to overcome the inertia and friction of the components that constitute the engine and to drive the engine, and may be understood as the torque required for idle operation of the engine, for example.

For example, the control torque of the first motor is set to the maximum torque of the first motor, and the first motor (P1) is controlled to apply this control torque in the direction opposite to the engine torque.

In other words, in the step S10, the engine torque is increased in advance to the extent that it can be absorbed or allowed by the first motor (P1), with the first motor being controlled to apply a control torque se to its maximum value and acting in the direction opposite to the engine torque. Then, in the step S20, during the vehicle launch, the engine clutch (EC) may be engaged more quickly, and, as a result of the additionally secured combined torque as shown in FIG. 4, the power performance of the vehicle can be enhanced.

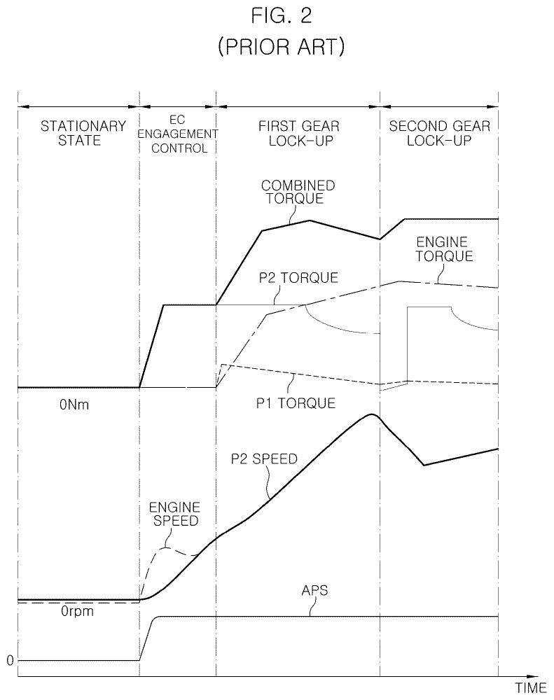

For reference, FIG. 4 illustrates that the combined torque of the engine torque, the first motor torque, and the second motor torque is additionally secured according to the embodiment of the present disclosure, compared to the conventional control method in FIG. 2.

For reference, in FIGS. 2, 4, 6, and 8, APS indicates the signal from the accelerator pedal sensor. The period during which APS initially maintains a value of 0 corresponds to the step of increasing the engine torque (S10), and the portion where the value begins to increase corresponds to the step of starting the vehicle (S20) in accordance with the driver's operation of the accelerator pedal 1.

When the reference speed of the first motor (P1) is below the minimum operable engine speed, the engine torque is determined by adding engine inertia torque to the maximum torque of the first motor (P1) at the minimum operable engine speed.

In other words, to enable quicker engagement of the engine clutch (EC) in the step of starting the vehicle (S20), it is advantageous to increase the engine torque as much as possible in the step of increasing the engine torque (S10). Therefore, when the first motor (P1) is driven at the minimum operable engine speed of the engine, the first motor (P1) generates the maximum torque that may be exerted in the direction opposite to the engine torque, allowing the engine torque to increase accordingly.

For example, the control torque of the first motor is set to the maximum torque of the first motor at the minimum operable engine speed, and the first motor (P1) is controlled to apply this control torque in the direction opposite to the engine torque.

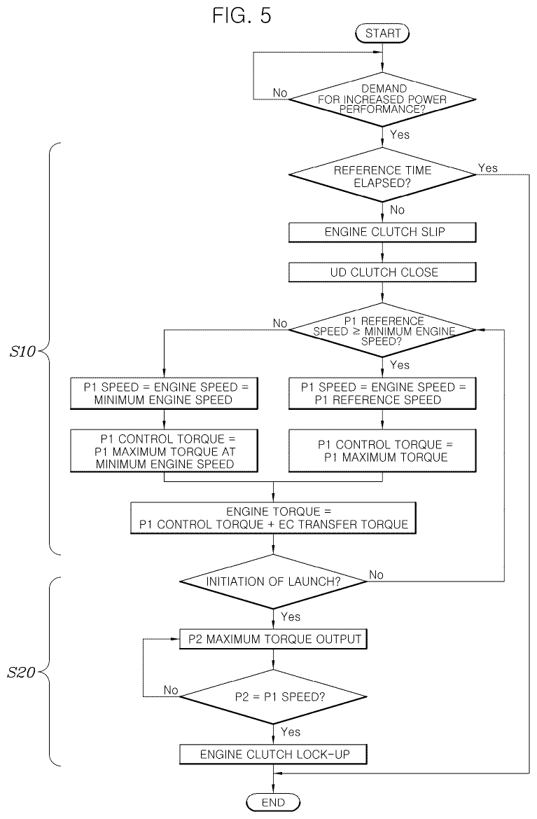

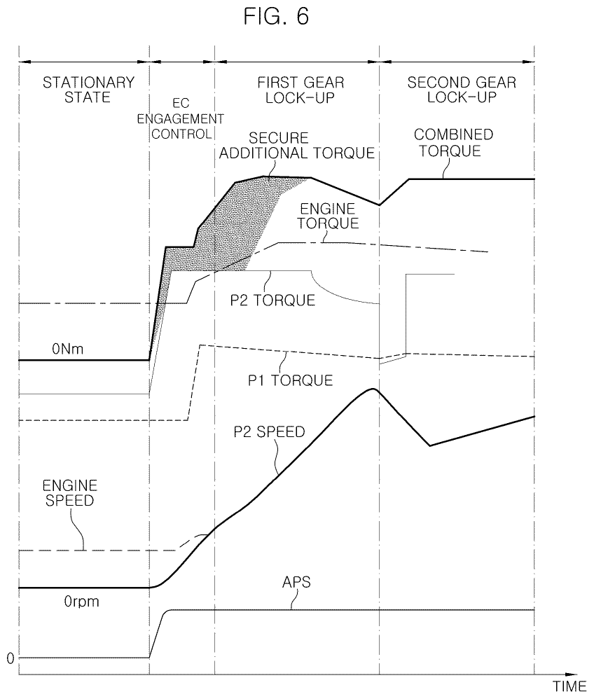

Referring to embodiments in FIGS. 5 and 6, in the step of increasing the engine torque (S10), the engine clutch (EC) is set to slip, the second motor (P2) is stopped, and the low-gear friction elements of the transmission (TM) are engaged. When the reference speed of the first motor (P1) is higher than or equal to the minimum operable engine speed, the engine torque is determined by adding the maximum torque of the first motor, the engine inertia torque, and the engine clutch slip torque.

In other words, in this embodiment, compared to the embodiments in FIGS. 3 and 4, the engine torque is pre-increased by an amount corresponding to the engine clutch slip torque, and the combined torque may increase more quickly and steeply, thereby further enhancing the power performance of the vehicle.

The engine clutch slip torque here is set to a value as high as possible within a range that prevents damage to the engine clutch (EC), i.e., within a range that does not degrade the durability performance of the engine clutch (EC), so that the magnitude of the pre-increased engine torque may be set as large as possible, and the durability of the engine clutch (EC) may be ensured.

In addition, the second motor (P2) is controlled to generate the second motor torque in the direction opposite to the engine torque, with the magnitude sufficient to absorb the engine clutch slip torque as described above and maintain a stationary state.

In other words, the control torque of the first motor is set to its maximum torque, and the first motor (P1) is controlled to apply this torque in the direction opposite to the engine torque. The engine clutch (EC) is controlled based on the engine clutch slip torque, which is determined within a range that prevents damage to the engine clutch (EC) while the second motor (P2) remains stationary (i.e., in a stationary state).

Accordingly, although the low-gear friction elements of the transmission (TM) are engaged, the vehicle remains stationary during the step of increasing the engine torque (S10). This is achieved by maintaining the second motor (P2) in a stationary state despite the slip of the engine clutch (EC). Then, in the step of starting the vehicle (S20), as the torque of the second motor (P2) increases, the pre-increased engine torque enables quicker engagement of the engine clutch (EC), and a greater combined torque is transferred to the drive wheels (W), thereby launching the vehicle.

When the reference speed of the first motor (P1) is below the minimum operable engine speed, the engine torque is determined by adding engine inertia torque and engine clutch slip torque to the maximum torque of the first motor at the minimum operable engine speed.

For example, the control torque of the first motor is set to the maximum torque of the first motor at the minimum operable engine speed, the first motor (P1) is controlled to apply this control torque in the direction opposite to the engine torque. The engine clutch (EC) is controlled based on the engine clutch slip torque, which is determined within a range that prevents damage to the engine clutch (EC) in a stationary state of the second motor (P2).

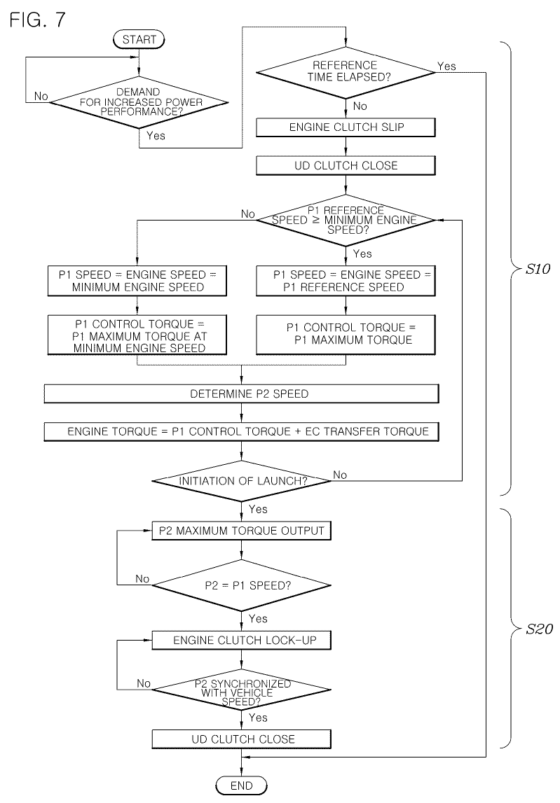

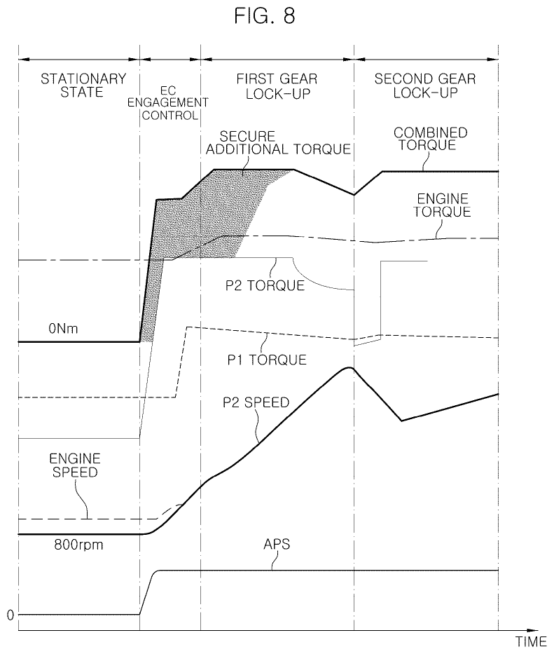

In embodiments shown in FIGS. 7 and 8, in the step of increasing the engine torque (S10), the engine clutch (EC) and the low-gear friction elements of the transmission (TM) are set to slip and the second motor (P2) rotates. When the reference speed of the first motor (P1) is higher than or equal to the minimum operable engine speed, the engine torque is determined by adding engine inertia torque and engine clutch slip torque to the maximum torque of the first motor. The rotational speed of the second motor (P2) is controlled based on the engine speed, the thermal capacity of the engine clutch (EC), and the thermal capacity of the low-gear friction elements of the transmission (TM).

For example, the control torque of the first motor (P1) is set to its maximum torque, and the first motor (P1) is controlled to apply this torque in the opposite direction of the engine torque. The second motor torque is controlled within a range that prevents damage to the engine clutch (EC) under a condition that a difference exists between the engine speed and the rotational speed of the second motor (P2), and the engine clutch (EC) is controlled based on the engine clutch slip torque, which is determined within a range that prevents damage to the engine clutch (EC) under a condition that a difference exists between the engine speed and the rotational speed of the second motor (P2).

In this embodiment, compared to the embodiments in FIGS. 3 and 4, the engine torque may be further pre-increased by an amount corresponding to the engine clutch slip torque. In addition, by rotating the second motor (P2) and allowing slip of the low-gear friction elements, the engine clutch slip torque may further increase, compared to the embodiments in FIGS. 5 and 6. Accordingly, the combined torque may increase more quickly and steeply, thereby further enhancing the power performance of the vehicle.

In this embodiment, the engine clutch slip torque may be set to a value greater than that of the embodiments in FIGS. 5 and 6. This is because the second motor (P2) is rotated by slipping the low-gear friction elements, which reduces the speed difference between both sides of the engine clutch (EC), compared to those shown in the above-described embodiments, and accordingly, even if a relatively high torque is applied to the engine clutch (EC), damage to or degradation in the durability of the engine clutch (EC) may be avoided.

In this situation, as the vehicle is required to remain stationary during the step of increasing the engine torque (S10), the slip of the low-gear friction elements is to occur within a range that allows the vehicle to remain stationary.

Under the slip condition of the low-gear friction elements described above, the rotational speed of the second motor (P2) may be determined by the following equation:

K*engine speed*low-gear friction element thermal capacity/(engine clutch (EC) thermal capacity+low-gear friction element thermal capacity), where K is a proportional constant.

If the engagement of the engine clutch (EC) is completed in the step of starting the vehicle (S20), and the rotational speed of the second motor (P2) is synchronized with the vehicle speed, and the low-gear friction elements are engaged.

In the step of increasing the engine torque (S10), when the reference speed of the first motor (P1) is below the minimum operable engine speed, the engine torque is determined by adding engine inertia torque and engine clutch slip torque to the maximum torque of the first motor at the minimum operable engine speed, and the rotational speed of the second motor (P2) is determined based on the engine speed, the engine clutch (EC) thermal capacity, and the thermal capacity of the low-gear friction elements of the transmission (TM).

For example, the control torque of the first motor is set to the maximum torque of the first motor at the minimum operable engine speed, and the first motor (P1) is controlled to apply this control torque in the direction opposite to the engine torque.

The torque of the second motor (P2) is controlled within a range that prevents damage to the engine clutch (EC) under a condition that a difference exists between the engine speed and the rotational speed of the second motor (P2).

The engine clutch (EC) is controlled based on the engine clutch slip torque determined within a range that prevents damage to the engine clutch (EC) under a condition that a difference exists between the engine speed and the rotational speed of the second motor (P2).

Based on the demand for increased power performance, if a predetermined reference time elapses following the initiation of the step of increasing the engine torque (S10), the step of increasing the engine torque (S10) and the step of starting the vehicle (S20) are released, thereby protecting the hybrid powertrain.

Releasing the step of increasing the engine torque (S10) and the step of starting the vehicle (S20) means releasing the control according to the present disclosure and returning to the standard control situation. If these steps are released during the starting of the vehicle, vehicle driving is controlled using a conventional vehicle starting control method.

Accordingly, the reference time may be set through experimentation and analysis to a level suitable for protecting the hybrid powertrain, and may be set to a level that may primarily protect the engine clutch (EC) and the low-gear friction elements. For example, the reference time may be set to 30 seconds.

In addition, based on the demand for increased power performance, if the temperature of at least one of the friction elements in the powertrain rises higher than or equal to a predetermined reference temperature following the initiation of the step of increasing the engine torque (S10), the step of increasing the engine torque (S10) and the step of starting the vehicle (S20) may also be released.

In other words, the reference temperature is suitably predetermined through experiment and analysis so that the engine clutch (EC) and the low-gear friction elements may be protected.

Although specific embodiments of the present disclosure have been illustrated and described, it should be apparent to those having ordinary skill in the art that various modifications and alterations may be made without departing from the technical spirit of the present disclosure provided in the appended claims below.

What is claimed is:

1. A method for controlling driving of a hybrid vehicle, the method comprising:
increasing an engine torque, prior to vehicle launch, within a range permitted by at least one motor or friction elements of a hybrid powertrain, based on a demand for increased power performance; and
starting the hybrid vehicle by engaging an engine clutch in response to an initiation of the hybrid vehicle launch.

2. The method of claim 1, wherein the hybrid powertrain includes:
an engine;
the at least one motor including a first motor directly connected to the engine, a second motor directly connected to a transmission; and
the engine clutch configured to control a connection between the first motor and the second motor.

3. The method of claim 2, wherein the friction elements of the hybrid powertrain include the engine clutch and low-gear friction elements of the transmission.

4. The method of claim 2, wherein increasing the engine torque includes:
based on determining that the engine clutch is open, and a reference speed of the first motor is greater than or equal to a minimum operable engine speed, determining the engine torque by adding an engine inertia torque to a maximum torque of the first motor.

5. The method of claim 4, wherein in increasing the engine torque, a control torque of the first motor is set to the maximum torque of the first motor, and the first motor is controlled to apply the control torque in a direction opposite to the engine torque.

6. The method of claim 2, wherein increasing the engine torque includes:
based on determining that the engine clutch is open, and a reference speed of the first motor is less than a minimum operable engine speed, determining the engine torque by adding an engine inertia torque to a maximum torque of the first motor at a minimum operable engine speed.

7. The method of claim 6, wherein in increasing the engine torque,
a control torque of the first motor is set to a maximum torque of the first motor at the minimum operable engine speed, and
the first motor is controlled to apply the control torque in a direction opposite to the engine torque.

8. The method of claim 2, wherein increasing the engine torque includes:
based on determining that the engine clutch is slipped, the second motor is stopped, and a reference speed of the first motor is greater than or equal to a minimum operable engine speed, determining the engine torque by adding an engine inertia torque and an engine clutch slip torque to a maximum torque of the first motor.

9. The method of claim 8, wherein in increasing the engine torque includes:
a control torque of the first motor is set to the maximum torque of the first motor, the first motor is controlled to apply the control torque in a direction opposite to the engine torque, and
the engine clutch is controlled based on the engine clutch slip torque, which is determined within a range that prevents damage to the engine clutch in a stationary state of the second motor.

10. The method of claim 2, wherein increasing the engine torque includes:
based on determining that the engine clutch is slipped, the second motor is stopped, and a reference speed of the first motor is less than a minimum operable engine speed, determining the engine torque by adding an engine inertia torque and an engine clutch slip torque to a maximum torque of the first motor at a minimum operable engine speed.

11. The method of claim 10, wherein in increasing the engine torque, a control torque of the first motor is set to the maximum torque of the first motor at the minimum operable engine speed, the first motor is controlled to apply the control torque in a direction opposite to the engine torque, and
the engine clutch is controlled based on the engine clutch slip torque, which is determined within a range that prevents damage to the engine clutch in a stationary state of the second motor.

12. The method of claim 2, wherein increasing the engine torque includes:
based on determining that the engine clutch and low-gear friction elements of the transmission are slipped, the second motor is rotated, a reference speed of the first motor is greater than or equal to a minimum operable engine speed, determining the engine torque by adding an engine inertia torque and an engine clutch slip torque to a maximum torque of the first motor, and
determining a rotational speed of the second motor based on a current engine speed, a thermal capacity of the engine clutch, and a thermal capacity of the low-gear friction elements of the transmission.

13. The method of claim 12, wherein in increasing the engine torque, a control torque of the first motor is set to the maximum torque of the first motor, the first motor is controlled to apply the control torque in a direction opposite to the engine torque,
a torque of the second motor is controlled within a range that prevents damage to the engine clutch under a condition that a difference exists between the engine speed and the rotational speed of the second motor, and
the engine clutch is controlled based on the engine clutch slip torque, which is determined within a range that prevents damage to the engine clutch under a condition that a difference exists between the engine speed and the rotational speed of the second motor.

14. The method of claim 12, wherein the rotational speed of the second motor is determined by an equation,
K*engine speed*low-gear friction element thermal capacity/(engine clutch thermal capacity+low-gear friction element thermal capacity), where K is a proportional constant.

15. The method of claim 12, further comprising:
engaging the low-gear friction elements based on determining that an engagement of the engine clutch has been completed during starting of the hybrid vehicle and that the rotational speed of the second motor is synchronized with a vehicle speed of the hybrid vehicle.

16. The method of claim 2, wherein increasing the engine torque includes:
based on determining that the engine clutch and low-gear friction elements of the transmission are slipped, the second motor is rotated, and a reference speed of the first motor is less than a minimum operable engine speed, determining the engine torque by adding an engine inertia torque and an engine clutch slip torque to a maximum torque of the first motor at a minimum operable engine speed, and
determining a rotational speed of the second motor based on an engine speed, a thermal capacity of the engine clutch, and a thermal capacity of the low-gear friction elements of the transmission.

17. The method of claim 16, wherein in increasing the engine torque, a control torque of the first motor is set to the maximum torque of the first motor at the minimum operable engine speed, the first motor is controlled to apply the control torque in a direction opposite to the engine torque,
a torque of the second motor is controlled within a range that prevents damage to the engine clutch under a condition that a difference exists between the engine speed and the rotational speed of the second motor, and
the engine clutch is controlled based on the engine clutch slip torque, which is determined within a range that prevents damage to the engine clutch under a condition that a difference exists between the engine speed and the rotational speed of the second motor.

18. The method of claim 1, wherein the demand for increased power performance is determined based on simultaneous operation of an accelerator pedal and a brake pedal.

19. The method of claim 1, wherein based on determining that a predetermined reference time has elapsed following an initiation of the increasing of the engine torque, the increasing of the engine torque and the starting of the hybrid vehicle are terminated.

20. The method of claim 1, wherein based on determining that a temperature of at least one of the friction elements in the hybrid powertrain rises higher than or equal to a predetermined reference temperature following an initiation of the increasing of the engine torque, the increasing of the engine torque and the starting of the hybrid vehicle are terminated.
